(19) United States
(12) Patent Application Publication
(10) Pub. No.: US 2007/0068757 A1
(43) Pub. Date: Mar. 29, 2007

(54) Easily assembled and transported cases and bags with wheels

(76) Inventor: Fu-Hsing Tan, Dongguan (CN)

Correspondence Address: PRO-TECHTOR INTERNATIONAL SERVICES, 20775 NORADA CT., SARATOGA, CA, 95070, US

(21) Appl. No.: 11/229,165

(22) Filed: Sep. 17, 2005

(30) Foreign Application Priority Data
Aug. 31, 2005 (CN) 200520063757.1

(51) Int. Cl. A45C 5/14; B62B 7/02; B62B 1/00

(52) U.S. Cl. 190/18 A; 280/47.26

(57) ABSTRACT

The present invention relates to technique of cases and bags and it mainly consists of the design of the base and the body of the case or bag and the method of connecting the base and the body together. The base and the body can be easily assembled and disassembled when necessary so it is very convenient for transportation and storage.

### FIELD OF THE INVENTION

The present invention relates to technique of the cases and bags, especially to easily assembled and transported cases and bags with truckles.

### BACKGROUND OF THE INVENTION

Cases and bags are commonly used in daily life as well as in sports, including suitcases in traveling, skiing bag in skiing, and bowing roller bag, etc. Usually the said cases or bags are constructed with a solid base connected with the body so as to form a space to contain objects. However, its structure makes it inevitable to take up a fairly large space. Besides, cases and bags are presently transported and sold as they have been totally assembled, which makes more cost for transportation and storage because as mentioned above, they take up large space.

### SUMMARY OF THE INVENTION

A main object of the present invention is to provide a new kind of case and bag that are convenient for manufacturing and for sale, and that can be easily assembled and disassembled by users so as to reduce the cost of transportation and storage.

To attain the object of the present invention, the base and the body of the case or bag can be not only assembled but also disassembled. At the part at which the base is connected with the body are some convexes and at the part at which the body is connected with the base are some concaves, and when the convexes are connected with the concaves, the base and the body are consequently connected. The same, at the part at which the base is connected with the body can be some concaves and at the part at which the body is connected with the base can be some convexes, and when the concaves are connected with the convexes, the base and the body are consequently connected. In detail, at the part at which the base is connected with the body are some protruding boards, on which there are some concaves; the same, at the part at which the body is connected with the base are some protruding boards on which there can be some concaves. Further more in detail, the concaves on the boards on the base may be the forms of holes; the same, the concaves on the boards on the body may be the forms of holes, too.

According to the present invention, the bases and the bodies of all kinds of cases and bags can be assembled and disassembled, which makes it convenient for the disassembling of cases and bags during transportation and storage so as to reduce the space the cargo originally took up. Therefore, the present invention can be applied to reduce the cost of transportation and storage as well as solve the problem of assembling the semi-finished products after transportation, at sale and before using. Additionally, if some parts of the cases and bags are destroyed or damaged, they can be easily replaced with new ones.

### DESCRIPTION OF THE DRAWINGS

For the purpose of making the invention easier to understand, some particular embodiments thereof will now be described with reference to the appended drawings in which:

FIG. 1 is the 3-D resolution sketch map of example 1 (skee bag) of the particular embodiments of the present invention.

FIG. 2 is the 3-D resolution sketch map of example 1 (bawling bag) of the particular embodiments of the present invention.

FIG. 3 is the 3-D resolution sketch map of example 1 (suitcase) of the particular embodiments of the present invention.

### DETAILED DESCRIPTION OF THE INVENTION

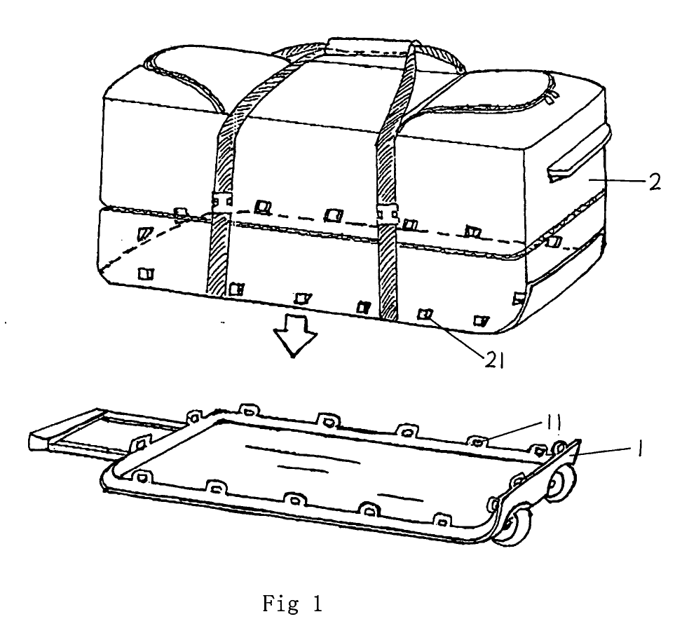

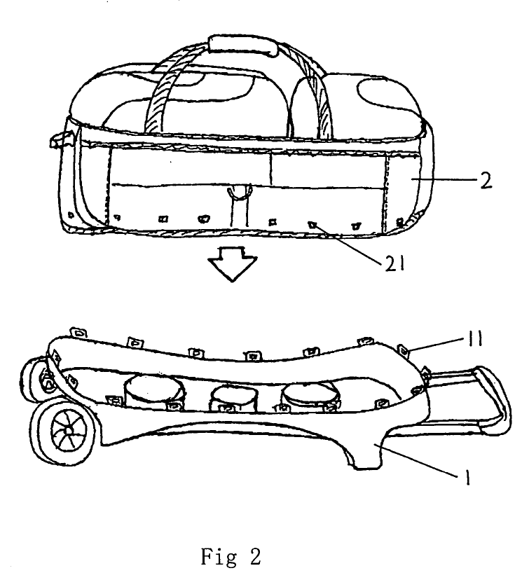

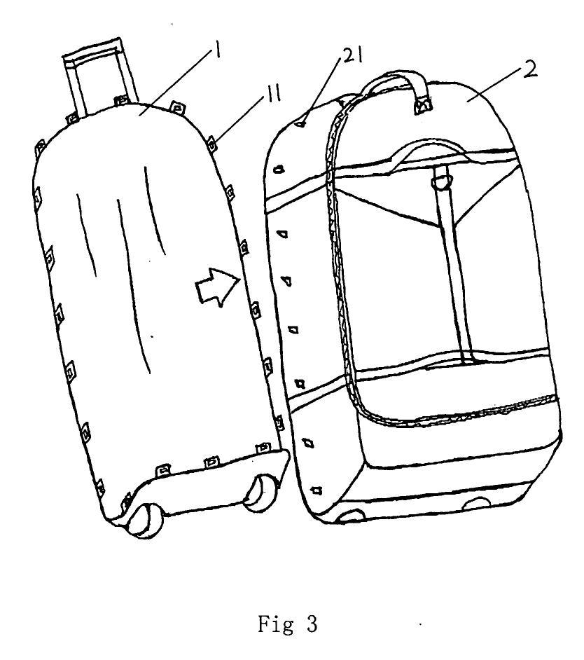

As illuminated in FIG. 1-3, the present invention includes the base 1, the body 2, some convexes 21 at the part where base 1 and the body 2 are connected, some concaves 11 on the base 1 related to the convexes 21, and the combination by connecting the concaves 11 on the base 1 with the convexes 21 on the body 2. The foresaid convexes and concaves can be also placed interchangeably on the base land the body 2; and the concaves may be like holes. Besides, the shape of convexes and concaves may change according to different cases and bags to be applicable. For convenience's sake, on the base 1 or on the body 2 may some protruding boards be placed and concaves are made on these protruding boards so as to make the solid parts flexible when being assembled.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A kind of case and bag that is convenient for assembling and transportation, comprising:
a base;
a body; wherein the base and the body can be easily combined and disassembled.

2. The case and bag as claimed in claim 1, wherein there are some convexes at the part where the body is connected with the base, and there are some concaves at the part where the base is connected with the body; the base and the body are combined by connecting the convexes with the concaves.

3. The case and bag as claimed in claim 1, wherein there are some concaves at the part where the body is connected with the base, and there are some convexes at the part where the base is connected with the body; the base and the body are combined by connecting the concaves with the convexes.

4. The case and bag as claimed in claim 2, wherein on the base there are some protruding boards at parts corresponding to convexes on the body, and the on the protruding boards there are some concaves.

5. The case and bag as claimed in claim 3, wherein on the body there are some protruding boards at parts corresponding to convexes on the base, and the on the protruding boards there are some concaves.

6. The case and bag as claimed in claim 2, wherein the concaves on the base may be holes.

7. The case and bag as claimed in claim 4, wherein the concaves on the base may be holes.

8. The case and bag as claimed in claim 3, wherein the concaves on the body may be holes.

9. The case and bag as claimed in claim 5, wherein the concaves on the body may be holes.
